(19) United States
(12) Patent Application Publication
(10) Pub. No.: US 2010/0219572 A1
(43) Pub. Date: Sep. 2, 2010

(54) Independent Spring Cartridge

(76) Inventor: Gary Back, Vesper, WI (US)

Correspondence Address: LANE PATENTS LLC, 100 NORTH 72ND AVE., SUITE 107, WAUSAU, WI, 54401, US

(21) Appl. No.: 12/715,799

(22) Filed: Mar. 2, 2010

Related U.S. Application Data
(60) Provisional application No. 61/156,655, filed on Mar. 2, 2009.

(51) Int. Cl. B60G 15/06

(52) U.S. Cl. 267/221

(57) ABSTRACT

An improved independent spring cartridge holder apparatus and system for holding an automobile suspension spring in tension while allowing a quick and safe change of the shock absorber and spring. This is especially valuable during a race where change outs need to be done quickly.

### REFERENCED APPLICATION(S)

The present application is a continuation of U.S. provisional patent application Ser. No. 61/156,655; filed Mar. 2, 2009, for Independent Spring Cartridge, included herein by reference and for which benefit of the priority date is hereby claimed.

### BACKGROUND OF THE INVENTION

1. Field of the Invention

The present invention relates to the field of vehicle suspension, and while the inventive concepts may be used in a wide variety of situations, the main embodiments will be directed more particularly to a preloaded spring suited for quick change in conditions such as racing.

2. Description of the Related Art

Many drivers, especially in race situations look to streamline the process of shock absorber or spring replacement or ride height adjustment. Many times during trial runs the shock absorbing characteristics of the car are found unsuitable for conditions anticipated during the actual race. In between pre-race practice sessions or during a race break the crew has a limited amount of time to get the car ready in multiple ways before the race. The shock absorber system typically comprises a coil spring and a shock damper. For proper loading, the damper extension is often less than the travel of the spring causing a difficult and possibly dangerous situation as the crew is required to partially compress the spring ad hoc to fit with the shock. Such procedures in best of conditions requires working with a compressed spring in tight quarters allowing little room for error. Therefore, the crew would prefer a solution which pre-loads the shock in such a way as to make the fully extended position of the spring less than the travel of the shock, and to be mounted with existing shock absorber systems.

The relevant art of interest describes various devices for holding and retaining springs from their full extension, also known as preloading.

U.S. Pat. No. 2,842,355 issued to Lang filed Apr. 8, 1954 discloses a structural cartridge for a spring to be used in a v belt pulley. It provides for preloading of a spring with a cartridge having two telescoping members mounted on a solid spindle. Such a configuration does not provide for interaction with the shock absorber with some of the other quick attach and release features of the present invention.

U.S. Pat. No. 3,128,985 issued to Wallerstein, Jr filed Apr. 14, 1964 discloses a mounting device for providing a damping effect through floating shoes which are slidably and tiltably mounted to allow for some lateral deflection in the spring while still being stable. It provides a separate structure being an encasement of the spring with no provision for a central shock absorber.

U.S. Pat. No. 3,157,392 issued to Kitamura filed May 3, 1962 discloses a spring dampening device mounted approximately in the mid section of the device for putting only a part of the spring in compression. This is done to dampen resonant vibrations in the spring. This methodology does not provide for the quick change mechanism required during a racing event.

U.S. Pat. No. 3,847,380 issued to Kearns filed Feb. 20, 1973 discloses a spring having a wire lacing extending between the adjacent helices of the main spring for creating a compressive loading on the spring. This may address an issue similar to the present invention, however in a different way.

### SUMMARY OF THE INVENTION

### BRIEF DESCRIPTION OF THE DRAWINGS

An understanding of the present invention may be obtained by reference to the accompanying drawings, when considered in conjunction with the subsequent, detailed description, in which:

FIG. 1A shows a side view of an independent device, in this case a shock absorber assembly, which can work as part of the supporting system;

FIG. 1B shows a side view of an embodiment of a cartridge and coil assembly;

FIG. 1C shows a side view of the independent device of FIG. 1A combined with the cartridge of 1B to form a completed supporting system;

FIGS. 1D and 1E show a top and bottom view respectively of the device of FIG. 1B;

FIGS. 2 and 2C show a through section view of a cartridge assembly under full extension and under compression;

FIG. 2A shows a detail view of an interface between cannular members derived from FIG. 2;

FIG. 2B shows a detail view of the retaining portion of the cartridge assembly of FIG. 2;

FIG. 2D shows a detail view of an interface between cannular members derived from FIG. 2C;

FIGS. 3, 3A, and 3B show; side, side, and top views respectively of a shock absorber assembly typical of the prior art, with a coiled spring having an extension length greater than working length of the shock absorber assembly;

FIGS. 4A and 4B show; side and bottom views respectively an inner cannulus of the embodiment shown in FIG. 3;

FIG. 4C shows an exploded view of the inner cannulus shown in FIGS. 4A and 4B;

FIGS. 5A and 5B show; side and top views respectively an outer cannulus of the embodiment shown in FIG. 3;

FIG. 5C shows an exploded view of the outer cannulus shown in FIGS. 5A and 5B;

FIGS. 6, 6A and 6D, show side, top and bottom view respectively for an alternative embodiment of a cartridge being loaded with a spring shown in FIG. 6B;

FIG. 6C shows a side view of the cartridge of FIG. 6 wherein the spring is compressed;

FIG. 7 shows a through section view of the cartridge of FIG. 6;

FIG. 7A shows a through section derived from FIG. 6 with a shock absorber embodiment being a variation of that shown in FIG. 3 to form an embodiment of the supporting system of the present invention;

FIG. 7B shows a through section derived from FIG. 7A in compression;

FIG. 7C shows a detail view from FIG. 7 illustrating the relationship between a stop ring and a slide ring;

FIGS. 8, 8A, 8B and 8C show schematic and sectional views of apparatus for assembling various embodiments of cartridges of the present invention.

### DESCRIPTION OF THE INVENTION

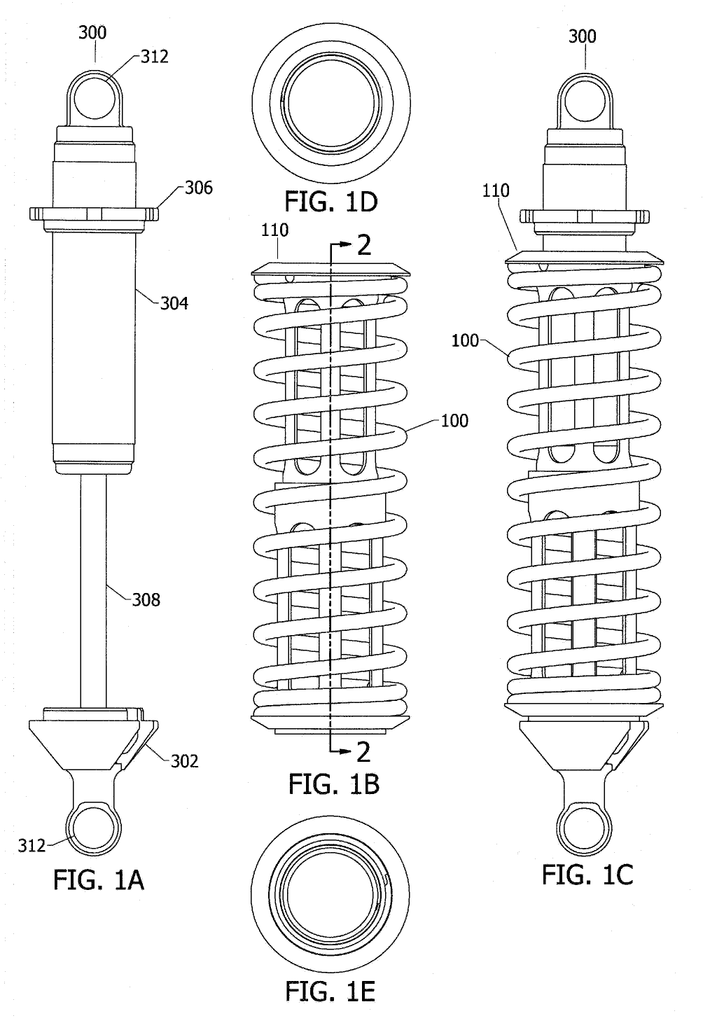

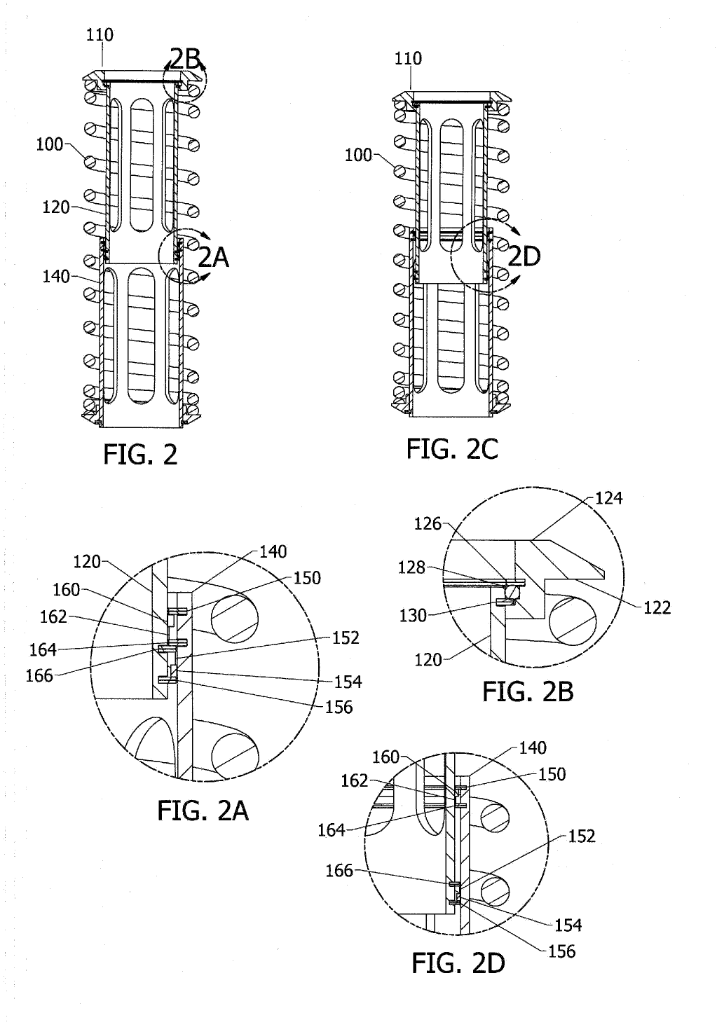

The supporting system assembly as shown in FIG. 1A-E shows a preferred embodiment having an inner modular sleeve 120, which can be generally described as a cannulus, lumen, or hollow sleeve of solid construction, and an outer modular sleeve 140, also described as a cannulus, lumen, or hollow sleeve of solid construction having an inner diameter sized to substantially match the outer diameter of the inner sleeve 120, and being positioned and mounted internally to the coils of a spring 100, the spring 100 being generally helical in form. Multiple flange members 124 having a pad 122 for engaging the spring 100 are typically located at the end portions of the springs 100 as shown in FIG. 2B, the flanges 124 being of sufficient diameter to engage the spring 100 and, when assembled, hold the spring in compression, or preload. An independent device 300, in this case a shock absorber, but may also include a strut, brace, damper, or the like, can be mounted coaxially with the cartridge assembly 110. In this case the shock 300, generally comprising a multiple of fasten points 312, such as eyelets suited for connecting a chassis member with a wheel member, and typically having a main body 304 and a piston rod 308 are situated coaxially with the cartridge assembly 110. In a preferred arrangement, the spring pad 302 is retracted from its seating location against the fasten point 312 and removed laterally away from the piston rod 308 via a slot cut through the section of the spring pad 302 allowing it to pass freely past the rod 308, and the device 300 is projected through the assembly 110. It is preferred that the body of the shock 304 and the inner sleeve 120 are sized and mounted to fit snuggly and move as one member as shown in FIG. 1C. After mounting the registration member 306 is attached and adjusted, typically by means of screwing down an adjusting nut onto the main body of the shock 304 which can be threaded. The position will be set as preferred by track and race conditions.

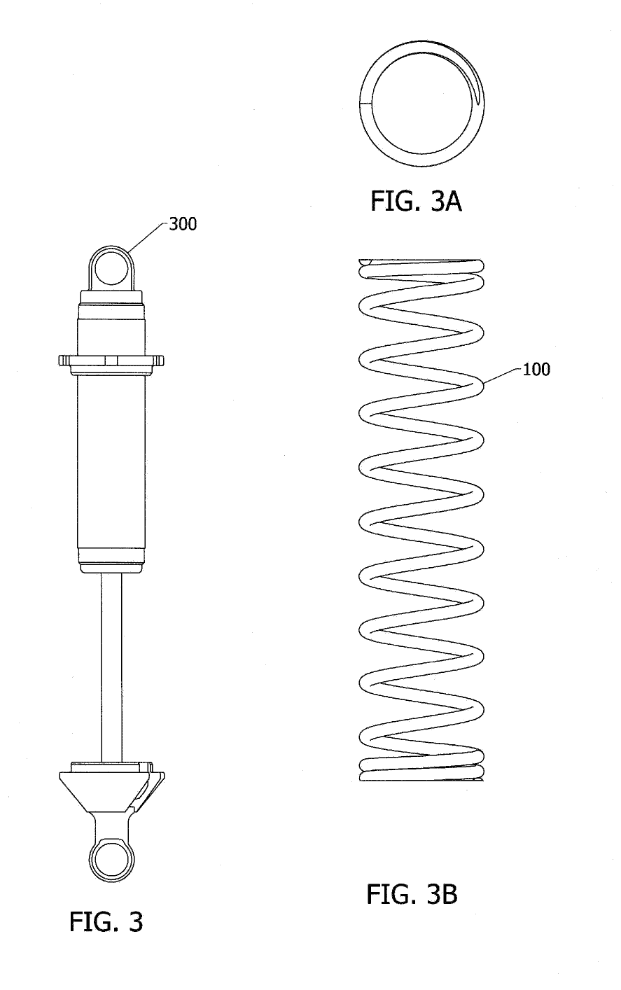

In operation, compressive forces on the vehicle (not shown) are transferred through the fasten points (312) and through the cartridge 110 and the shock 300, which generally act together as one unit. While under extended conditions when no compression is applied, a series of retaining rings, referred to here as a superior interior spiral retaining ring 164 and an inferior interior retaining ring 166, abut to limit movement of the two sleeves 120 and 140 to maintain constraint on the system to a predetermined length. Without such constraint, the extension length of the coil spring 100 would tend to be greater than the distance between the spring pad 302 and the registration (adjusting nut) 306 as illustrated in FIGS. 3 and 3B, making it difficult to replace a shock, or a spring, or adjust the ride height in race conditions.

However with the system, as compression is applied generally by the weight of the vehicle, cornering, or bumps in the road, the sleeves 120 and 140 slide with respect to one another, as shown in FIG. 2D, allowing compression of the system with regard to the coil spring 100 and shock absorber 300. It is preferred to have a series of wear bands 154, 160 and the like located at the interface between the inner sleeve 120 and the outer sleeve 140 to improve performance and wear-ability. It is anticipated in alternate embodiments that the interface points may be further provided with slidable means such as bearings, Teflon® bushings or the like in order to facilitate ease of movement

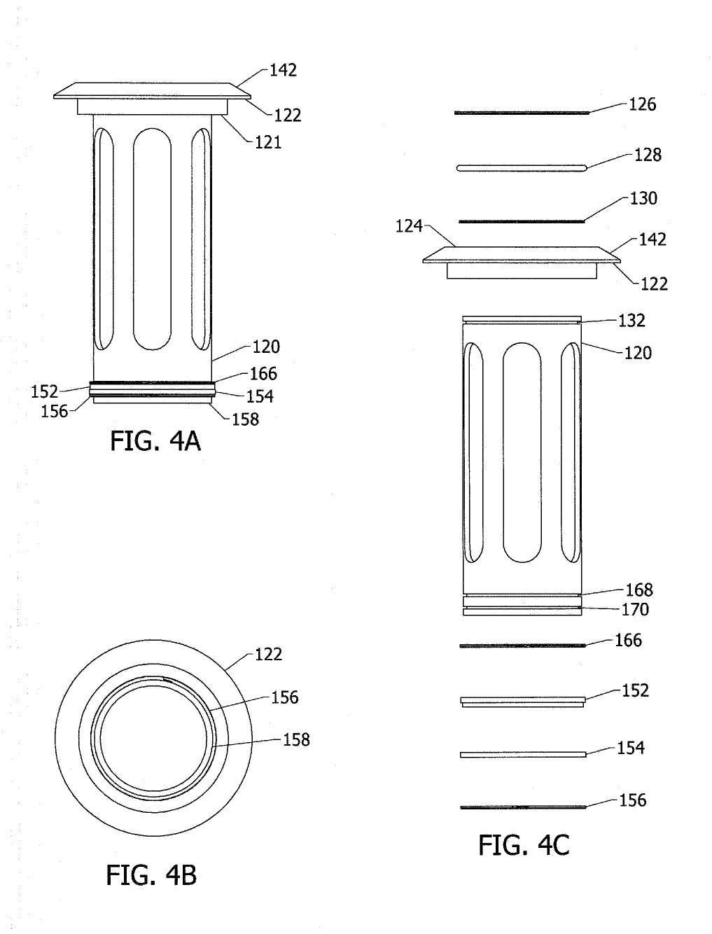

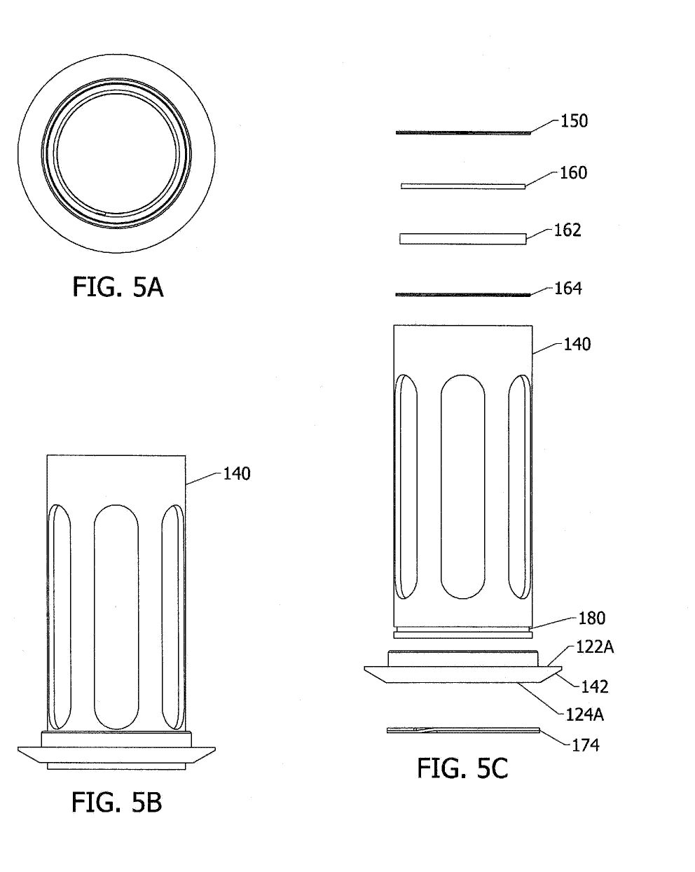

With the adjusting nut 306 riding on spring pad 124, it is preferred to have a chamfer 142 to minimize impingement. Further a mechanism is helpful to lock the spring pad 124 in place. Therefore a mechanism of a spiral retaining ring 130 followed by a tension band 128 and a spring retaining band 126 is provided to hold the spring pad 124 in place as shown in FIG. 2B and further illustrated in the exploded view of FIG. 4C. A series of retaining grooves 132, 168, 170, 172, 180 can be formed into the cartridge assembly to accommodate the holding and retaining of retaining rings 126, 130, 150, 164, 166, 156, 174, stop rings 152 wear bands 154 and the like. Those skilled in the art will appreciate the universal applicability of such a system. Further those skilled in the art will appreciate that other means, such as weldments or permanent structures can be utilized in place of the retaining ring system in several places.

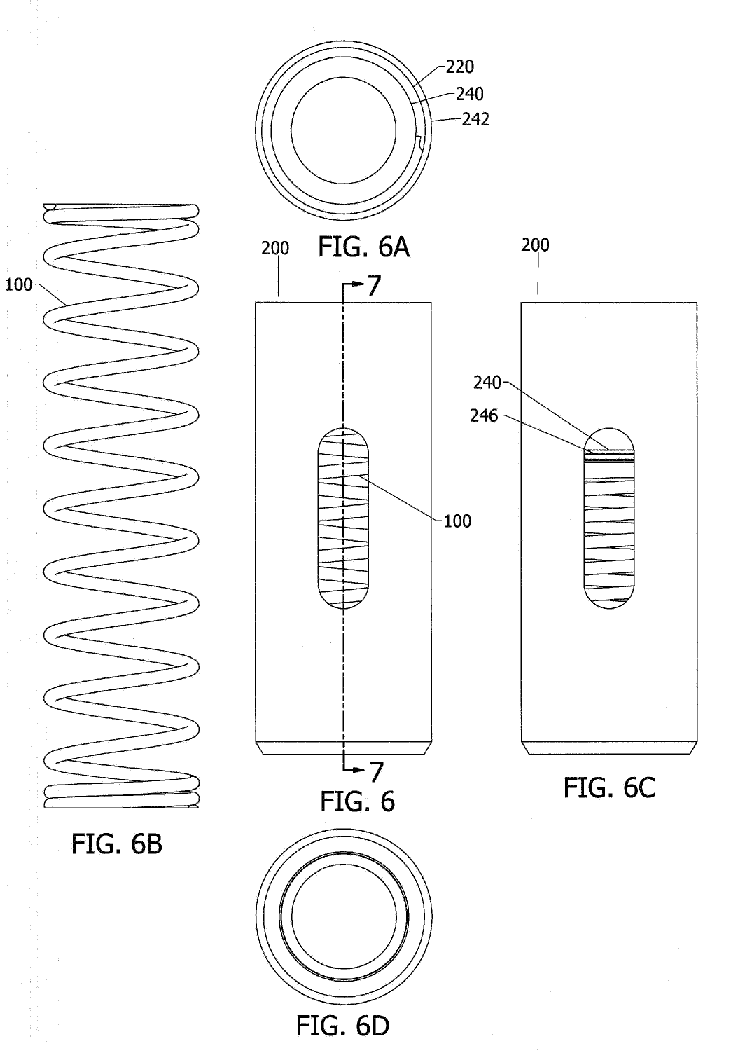

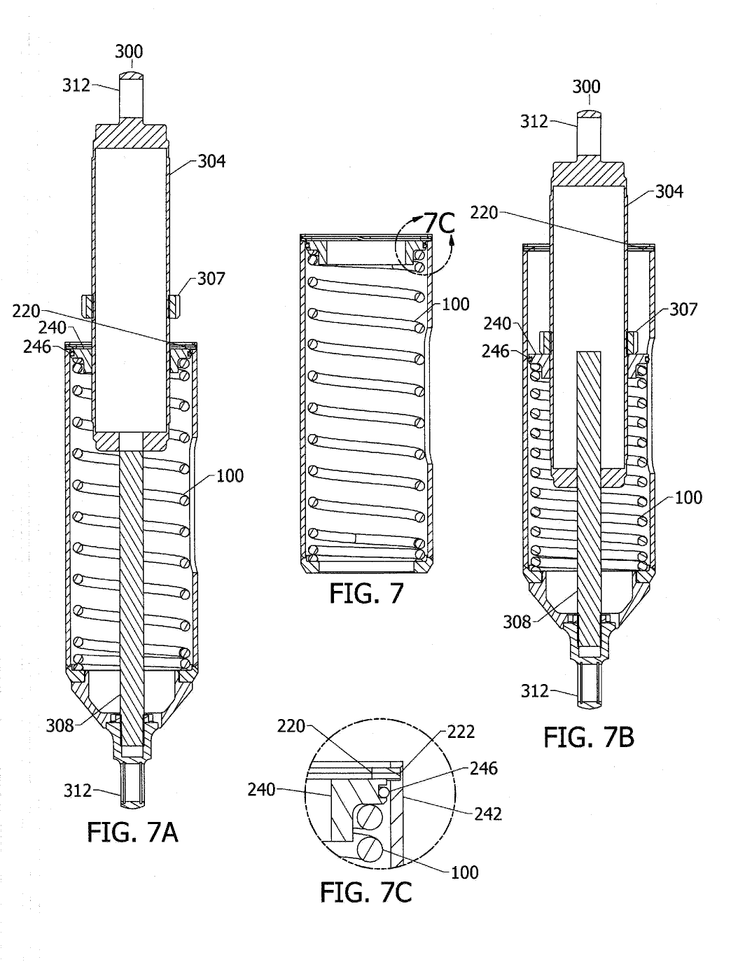

In some alternate embodiments such as is shown in FIGS. 6-6D and 7-7C, the cartridge 304 can be designed to encompass the coil spring 100. In this embodiment, the adjusting nut 307 can engage with the spring pad 240 near the top of the cartridge 304. The spring pad 240 and the wear band 246 are designed to move into the cartridge 304 upon compression as is shown in FIG. 7B. The piston rod 308 then moves into the main body of the shock 304 of the independent device 300 as the fasten points 312 come closer together upon compression.

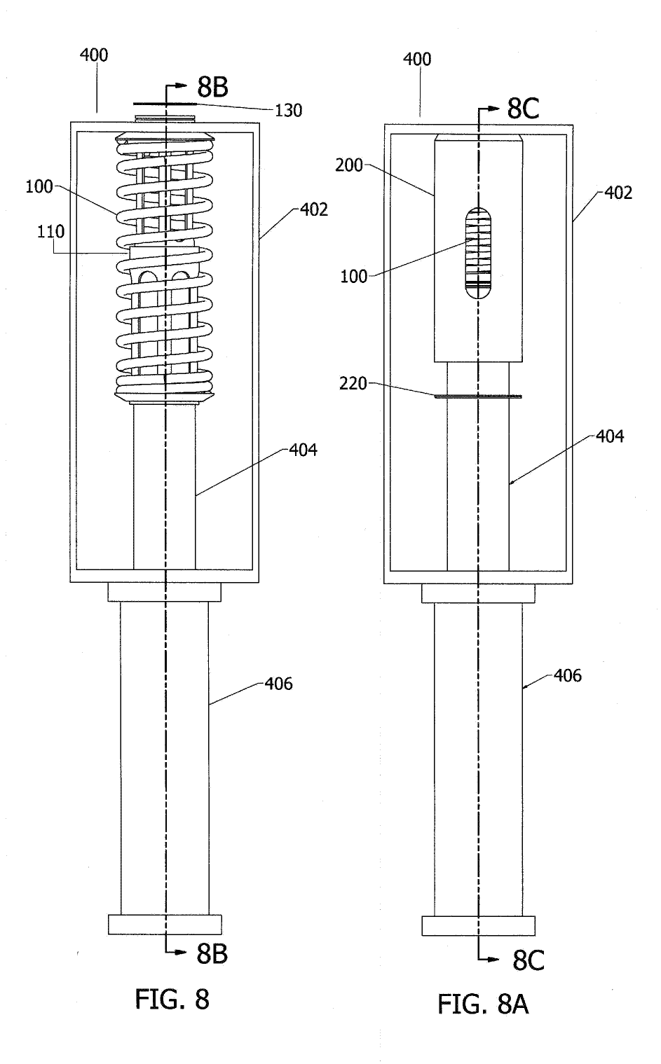

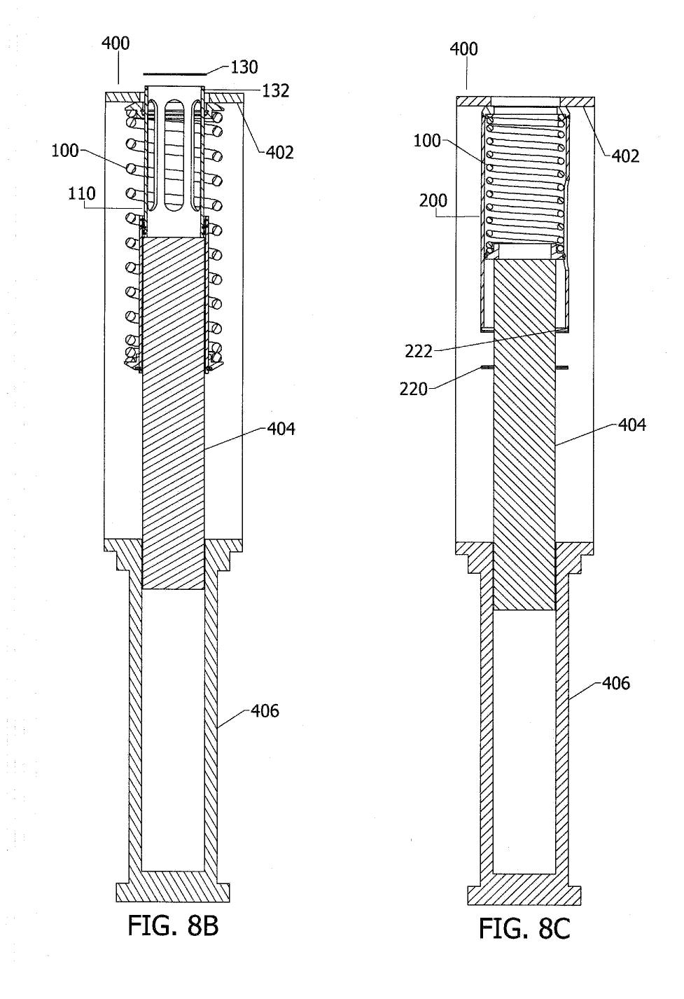

FIGS. 8 and 8B illustrate a cartridge assembly system 400. In this instance as an illustration, a cartridge assembly 110 is preassembled with a spring 100 and a spring pad 124 placed on the top. The piston 404, typically associated with a hydraulic cylinder 406, such as a single acting hydraulic cylinder known in the art, is rammed into the inner sleeve 120 of a cartridge assembly 110 causing the groove ring 132 at the top of the cartridge 110 to protrude above the frame section 402, allowing a spiral retaining ring 130 to be applied.

In an alternate embodiment shown in FIGS. 8A and 8C, the cartridge 200 can be reversed such that it abuts the frame section 402 with the piston 404 depressing the spring pad 240 allowing the spiral retaining ring 220 to be situated with the ring groove 222, thereby forming a seal.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form.

Having thus described the invention, what is desired to be protected by Letters Patent is presented in the subsequently appended claims.

What is claimed is:

1. A supporting system comprising a supporting device being designed to work coaxially with an associated independent device comprising:
a. a coiled spring having a first end and a second end and an intermediate portion of predetermined extension length, the extension length substantially being equal to or greater than the working length of said independent device;
b. a cartridge comprising at least one cannular member comprising a first interface region being adapted to receive at least one end of the coiled spring;
c. at least one mounting body comprising a second interface region adapted to receive the other end of the coiled spring;
d. said mounting body being slidably associated with the cannular member and constrained such that the length of the cartridge, when fully extended, is less than the length of the coiled spring;
e. the coiled spring being securely mounted with the cannular member such that the cannular member limits the distance of travel of the coiled spring;
f. the independent device and cartridge being arranged in such a way that the independent device can be quickly and safely replaced.

2. A supporting system in accordance with claim 1 wherein the independent device comprises a shock absorber comprising a main body and a rod, and having a momentum dampening mechanism.

3. A supporting system in accordance with claim 2 wherein the shock absorber comprises a predetermined length and distance of travel.

4. A supporting system in accordance with claim 2 wherein the cartridge is aligned internal to the coils of the spring.

5. A supporting system in accordance with claim 4 wherein the cartridge further comprises a first cannular member in a nested configuration with a second cannular member.

6. A supporting system in accordance with claim 5 wherein the first and second cannular members operate in a telescoping fashion the inner cannulus being matched with the main body of the shock absorber.

7. A supporting system in accordance with claim 6 wherein the movement of the inner cannulus substantially coincides with the movement of the main body.

8. A supporting system in accordance with claim 6 wherein the telescoping cannular members further comprise at least one stop ring and at least one slide ring.

9. A supporting system in accordance with claim 1 wherein the cartridge encompasses the coils of the spring.

10. A supporting system in accordance with claim 9 wherein the mounting body is slide-ably associated with the cartridge.

11. A shock absorber system comprising a spring cartridge and a shock absorber wherein the spring is preloaded into the cartridge restricting the extension of the spring to be less than the extension of the shock absorber comprising:
a. a shock absorber having a momentum dampening mechanism, the shock absorber having a predetermined length and distance of travel;
b. a coiled spring having a first end and a second end and an intermediate portion of predetermined extension length, the extension length substantially being equal to or greater than the length of said shock absorber;
c. a cartridge comprising at least one cannular sleeve comprising a first interface region being adapted to receive at least one end of the coiled spring;
d. at least one mounting body comprising a second interface region adapted to receive the other end of the coiled spring;
e. said mounting body being slidably associated with the cannular sleeve and constrained such that the length of the cartridge, when fully extended, is less than the length of the coiled spring;
f. the coiled spring being securely mounted with the cannular sleeve such that the cannular sleeve limits the distance of travel of the coiled spring;
g. the shock absorber and cartridge being arranged in such a way that the shock absorber can be quickly and safely removed or replaced.

12. A shock absorber system in accordance with claim 11 wherein the shock absorber further comprises eyelets adapted for connecting the shock absorber between a chassis and an axis of a vehicle, the eyelets being easily accessible for removal or replacement.

13. A shock absorber system in accordance with claim 11 wherein the shock absorber and the cartridge are arranged in such a way that the ride height adjusting nut is retracted from the cartridge leaving the adjusting nut free to be rotated for the purpose of adjusting the vehicle ride height when the vehicle chassis is raised and the shock absorber is in an extended position.

14. A shock absorber system in accordance with claim 11 wherein the cartridge is aligned internal to the coils of the spring.

15. A shock absorber system in accordance with claim 12 wherein the cartridge further comprises a first sleeve being arranged in a nested configuration with a second sleeve whereby the movement between the sleeves corresponds with the movement of the shock absorber.

16. A shock absorber system in accordance with claim 12 wherein the cartridge encompasses the coils of the spring.

17. A shock absorber system in accordance with claim 16 wherein the first interface region is permanently joined with the cartridge.

18. A shock absorber system in accordance with claim 17 wherein the second interface region is abutted with the cartridge by means of a retaining ring.

19. A shock absorber system in accordance with claim 17 wherein the second interface region is slide-ably contained within the abutted region.

20. A shock absorber system with a spring cartridge and a shock absorber wherein the spring is preloaded restricting the travel of the spring to be less than the extension of the shock absorber comprising:
a. a shock absorber having a momentum dampening mechanism, the shock absorber having a predetermined length and distance of travel;
b. a coiled spring having a predetermined extension length, the length being greater than the distance of travel of said shock absorber;
c. a cartridge having an outer sleeve having an interface point, an inner sleeve having an interface point;
d. said inner sleeve and said outer sleeve being telescopically and moveably connected at said interface points such that the interface points constrain the movement of the inner sleeve and the outer sleeve such that the length of the cartridge, when fully extended, is less than the length of the coiled spring;
e. the coiled spring being securely mounted with the cartridge such that the cartridge limits the distance of travel of the coiled spring;
f. the shock absorber and cartridge being arranged in such a way that the shock absorber can be quickly and safely replaced.
